(19) United States
(12) Patent Application Publication
(10) Pub. No.: US 2026/0044698 A1
(43) Pub. Date: Feb. 12, 2026

(54) IMAGE FORMING APPARATUS AND CONTROL METHOD FOR IMAGE FORMING APPARATUS

(71) Applicant: Konica Minolta, Inc., Tokyo (JP)

(72) Inventor: Kengo CHIHARA, Tokyo (JP)

(73) Assignee: Konica Minolta, Inc., Tokyo (JP)

(21) Appl. No.: 19/291,113

(22) Filed: Aug. 5, 2025

(30) Foreign Application Priority Data
Aug. 6, 2024 (JP) 2024-130053

(51) Int. Cl. G06K 15/02; B41J 2/21; B41J 11/00; B41J 29/393

(52) U.S. Cl. CPC G06K 15/027; B41J 2/2135; B41J 11/00214; B41J 11/0095; B41J 29/393; G06K 2215/0094; G06K 2215/101

(57) ABSTRACT

An image forming apparatus includes: an image former; a color measurer; a hardware processor that continuously performs the color measurement of the image since immediately after the test printing and identify a color value after color stabilization; and a memory that stores as history data color measurement results and image formation conditions in past test printing. While continuously performing the color measurement in the new test printing, the hardware processor refers to a color measurement result under an image formation condition identical or similar to an image formation condition of the new test printing. Upon identifying that a difference in transition between the time-series color measurement data in the new test printing up to a current time point and the time-series color measurement data that has been referred to is equal to or smaller than a predetermined value, the hardware processor terminates the color measurement at that time point.

### CROSS REFERENCE TO RELATED APPLICATIONS

Japanese Patent Application No. 2024-130053 filed on Aug. 6, 2024, including description, claims, drawings, and abstract, the entire disclosure of which is incorporated herein by reference.

### BACKGROUND

### Technical Field

The present disclosure relates to an image forming apparatus and a control method for the image forming apparatus.

### Description of Related Art

In general, in an inkjet type image forming apparatus, test printing is performed on a recording medium, a printed pattern is subjected to color measurement by a colorimeter, and a correction value for performing density gradation correction or the like is updated based on the obtained color value. See, e.g., PTL 1 (Japanese Unexamined Patent Publication No. 2015-131483).

The ink used in this type of image forming apparatus requires a certain amount of time to stabilize the color after being ejected onto the recording medium. Therefore, particularly in industrial printing or the like, in order to meet the demand for accurate color reproducibility, color measurement by a colorimeter is performed after waiting until the color is stabilized after image formation.

FIG. 1 is a diagram illustrating an example of a temporal transition of a color change of an image formed on a recording medium. In FIG. 1, the horizontal axis represents elapsed time from immediately after image formation. In addition, the vertical axis represents the color difference (that is, the amount of change from the initial value) of the color value measured at each time point.

In general, the stabilization time until the ink is dried on the recording medium and the color is stabilized varies depending on various factors such as the type of the recording medium, the type of the ink, and the temperature and the humidity during printing. Therefore, for example, in PTL 1, processing is performed in which color measurement is periodically repeated, and when a color change per unit elapsed time becomes small, it is considered that the color is stabilized, and final color measurement is performed.

However, in the known technology according to PTL 1, the image forming apparatus needs to wait until the ink actually dries on the recording medium and the color stabilizes. Therefore, printing cannot be performed during the waiting period, which results in downtime.

The present invention has been made in view of the above-mentioned problems. That is, an object of the present invention is to provide an image forming apparatus capable of specifying, in a shorter time, a color value after color stabilization of an image formed in various use situations, and a control method thereof.

Note that here, the “color value” means color information relating to hue, brightness, and saturation. However, the “color value” may be represented by an arbitrary color space coordinate system such as a Lab color space or an RGB color space.

### SUMMARY

In order to achieve at least one of the above-described objects, an image forming apparatus reflecting one aspect of the present invention includes: an image former that forms an image on a recording medium by ink ejection; a color measurer that performs color measurement of the image formed on the recording medium; a hardware processor that controls operations of the image former and the color measurer to: perform test printing; continuously perform the color measurement of the image since immediately after the image is formed in the test printing; and identify a color value after color stabilization of the image based on time-series color measurement data; and a memory that stores, as history data, color measurement results and image formation conditions in past test printing in association with each other. While performing new test printing and continuously performing the color measurement of the image formed in the new test printing, the hardware processor refers to, from among the color measurement results stored as the history data, a color measurement result under an image formation condition identical or similar to an image formation condition of the new test printing. Upon identifying that a difference in transition between the time-series color measurement data of the image formed in the new test printing that has been obtained up to a current time point and the time-series color measurement data on the color measurement result stored as the history data that has been referred to is equal to or smaller than a predetermined value, the hardware processor terminates the color measurement at that time point.

A control method reflecting one aspect of the present invention is a method for an image forming apparatus that performs test printing and continuously performs color measurement of an image since immediately after the image is formed on a recording medium in the test printing, and identifies a color value after color stabilization of the image based on time-series color measurement data, the method including: storing, as history data in a memory, color measurement results and image formation conditions in past test printing in association with each other; referring to, from among the color measurement results stored as the history data, a color measurement result under an image formation condition identical or similar to an image formation condition of new test printing; and upon identifying that a difference in transition between the time-series color measurement data of the image formed in the new test printing that has been obtained up to a current time point and the time-series color measurement data on the color measurement result stored as the history data that has been referred to is equal to or smaller than a predetermined value, terminating the color measurement at that time point.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an example of temporal transition of color change of an image formed on a recording medium;

FIG. 2 is a diagram illustrating a schematic configuration of an image forming apparatus according to an embodiment;

FIG. 3 is a schematic diagram illustrating a configuration of a head unit according to the embodiment and includes;

FIG. 4 is a block diagram illustrating a configuration of a control system of the image forming apparatus according to the embodiment;

FIG. 5 is a diagram illustrating an example of history data stored in a storage according to the embodiment;

FIG. 6 is a diagram illustrating an example of an operation flow of a controller according to the embodiment; and

FIG. 7 is a diagram illustrating a time-saving color measurement flow of step S7 to S10 of FIG. 6.

### DETAILED DESCRIPTION OF EMBODIMENTS

Hereinafter, one or more embodiments of the present invention will be described with reference to the drawings. However, the scope of the invention is not limited to the disclosed embodiments.

In the following, preferred embodiments of the present disclosure will be described in detail with reference to the accompanying drawings. In this specification and the drawings, constituent elements having substantially the same functions are denoted by the same reference numerals, and redundant description thereof will be omitted.

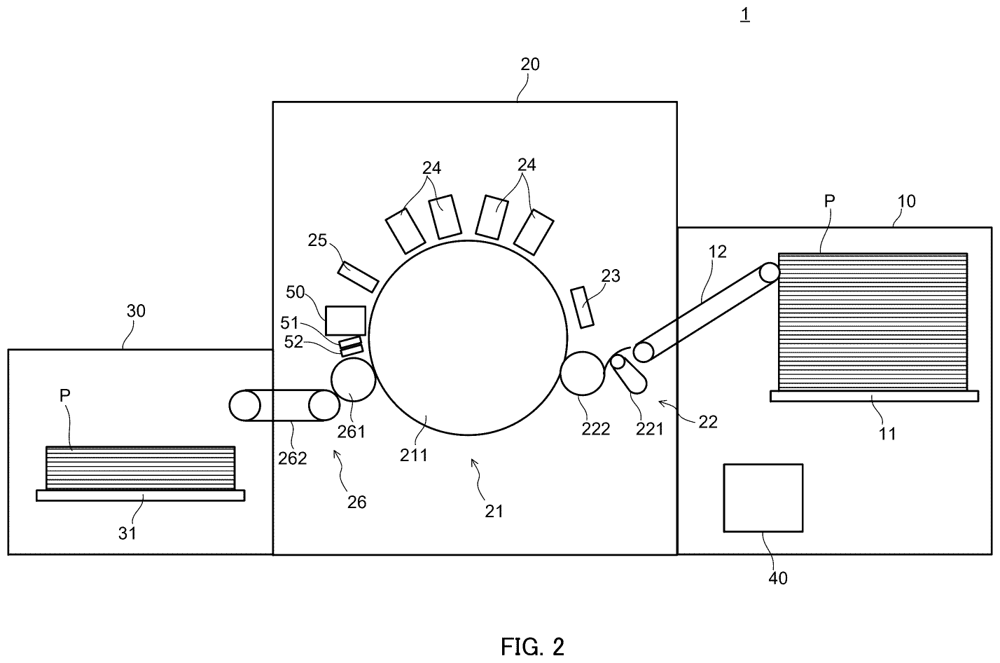

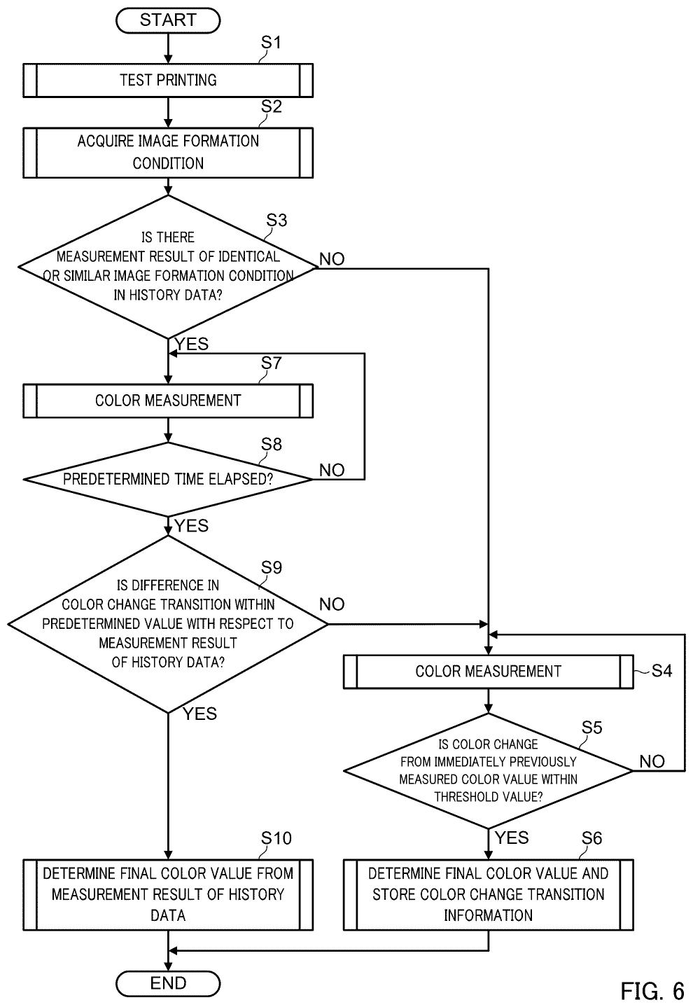

Hereinafter, an example of a configuration of an image forming apparatus (hereinafter, referred to as an “image forming apparatus 1”) according to an embodiment of the present invention will be described with reference to FIGS. 2 to 4. Note that the image forming apparatus 1 is configured to perform test printing (see FIG. 6 and the like) as calibration processing before performing main printing, in order to perform tone correction and the like of density suited to an image formation condition.

FIG. 2 is a diagram illustrating a schematic configuration of the image forming apparatus 1.

The image forming apparatus 1 is an inkjet image forming apparatus that forms an image by ejecting (jetting) ink from nozzles formed in recording head 240 and landing the ink on a recording medium P, such as a sheet.

The image forming apparatus 1 includes a sheet feeder 10, an image former (or image forming unit/device) 20, a sheet ejector 30, a controller 40, and a color measurer (or color measuring unit/device or colorimeter) 50.

The image forming apparatus 1, under control of the controller 40, conveys the recording medium P stacked in the sheet feeder 10 to the image former 20, ejects ink onto the recording medium P at the image former 20 to record an image thereon, and conveys the recording medium P having the image recorded thereon to the sheet ejector 30. In addition, the image forming apparatus 1 is configured to be able to perform color measurement of an image formed by the image former 20 in the color measurer 50 as necessary at the time of test printing or the like.

Specifically, the image forming apparatus 1 records a color image on the recording medium P by outputting four colors of yellow (Y), magenta (M), cyan (C), and black (K) with a predetermined number of recording gradations each in a superimposed manner on the recording medium P. Note that hereinafter, the ink colors of yellow (Y), magenta (M), cyan (C), and black (K) will be referred to as Y, M, C, and K, respectively.

As the recording medium P, in addition to sheet such as a plain paper or a coated paper, various media can be used on which ink having landed on the surface can be fixed, such as textile or sheet-like resin. In the present embodiment, a sheet is used as the recording medium P.

The sheet feeder 10 includes a sheet feed tray 11 that stores the recording medium P, and a medium supplier 12 that conveys and supplies the recording medium P from the sheet feed tray 11 to the image former 20. The medium supplier 12 includes a ring-shaped belt whose inner side is supported by two rollers, and rotates the rollers while the recording medium P is placed on the belt to convey the recording medium P from the sheet feed tray 11 to the image former 20.

The image former 20 includes a conveyor 21, a handover unit 22, a heating unit 23, a head unit 24, a fixer 25, and a deliverer (or delivery unit) 26.

The conveyor 21 holds the recording medium P placed on a conveyance surface of a cylindrical conveyance drum 211. Next, the conveyance drum 211 rotates and circulates around the rotation shaft to convey the recording medium P on the conveyance drum 211 in a conveyance direction along the conveyance surface.

The conveyance drum 211 includes a claw and a suction part (not illustrated) for holding the recording medium P on the conveyance surface. The recording medium P is held on the conveyance surface by being pressed at the end by the claw and by being sucked to the conveyance surface by the suction part.

The handover unit 22 is provided at a position between the medium supplier 12 of the sheet feeder 10 and the conveyor 21. The handover unit 22 holds one end of the recording medium P conveyed from the medium supplier 12 with a swing arm 221 to pick the recording medium P up, and then hands over the recording medium P to the conveyor 21 via the handover drum 222.

The heating unit 23 is provided between an arrangement position of the handover drum 222 and an arrangement position of the head unit 24. The heating unit 23 heats the recording medium P so that the recording medium P conveyed by the conveyor 21 has a temperature within a predetermined temperature range. The heating unit 23 includes, for example, an infrared heater or the like, and energizes the infrared heater on the basis of a control signal supplied from the controller 40 to cause the infrared heater to generate heat.

The head unit 24 records an image by ejecting ink onto the recording medium P at appropriate timings corresponding to the rotation of the conveyance drum 211 on which the recording medium P is held.

The head unit 24 is arranged such that its ink ejection surface and the conveyance surface of the conveyance drum 211 are separated from each other by a predetermined distance. In the image forming apparatus 1 of the present embodiment, the four head units 24 respectively corresponding to the inks of the four colors of Y, M, C, and K are arranged at predetermined intervals in the order of the colors of Y, M, C, and K from the upstream side in the conveyance direction of the recording medium P.

The head unit 24 is used while its position is fixed when an image is formed, and sequentially ejects ink at predetermined intervals to different positions in the conveyance direction in accordance with the conveyance of the recording medium P, thereby forming an image by a single-pass method. Note that the image formation by the head unit 24 may be performed by a scanning method instead of the single-pass method.

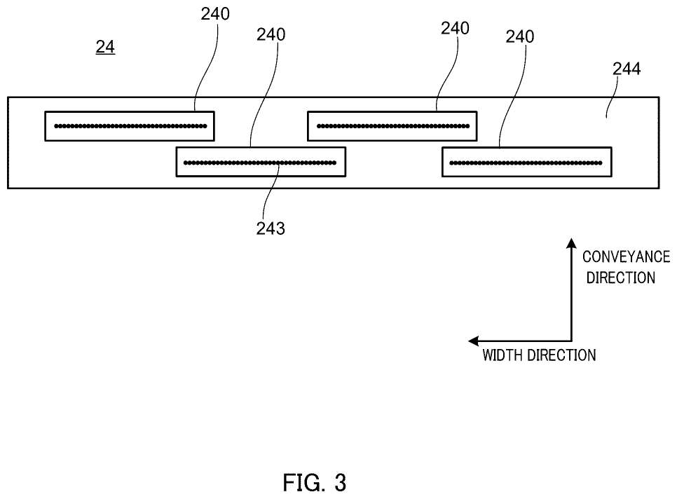

FIG. 3 is a schematic diagram illustrating a configuration of the head unit 24. FIG. 3 illustrates an ink ejection surface of the head unit 24.

Here, the head unit 24 includes four recording heads 240 attached to the attachment member 244. In the recording head 240, a plurality of image forming elements each including a pressure chamber (not illustrated) for storing ink, a piezoelectric element (not illustrated) provided on a wall surface of the pressure chamber, and a nozzle 243 communicated with the pressure chamber are provided in a row along a width direction of the recording medium P. In the image forming element, when a drive signal for deforming the piezoelectric element is input, the deformation of the piezoelectric element deforms the pressure chamber to change the pressure in the pressure chamber, thereby ejecting ink from the nozzle 243 communicating with the pressure chamber. Accordingly, in each of the four recording heads 240, ink droplets of a liquid amount corresponding to the pixel value of the image data are discharged from the nozzles 243 toward the recording medium P, and an image is formed on the recording medium P carried on the conveyance drum 211.

The four recording heads 240 are arranged in a staggered manner so that the arrangement range in the width direction of the recording medium P is continuously connected. The arrangement range of the nozzles 243 included in the four recording heads 240 in the width direction of the recording medium P covers the entire width in the width direction of the recording medium P in an area where an image is formed on the recording medium P conveyed by the conveyance drum 211. That is, the head unit 24 constitutes a line head capable of ejecting ink over an image formable width in the width direction of the recording medium P with respect to the recording medium P.

The recording head 240 includes an ink heating part (not illustrated) that heats ink stored in the recording head 240, and ejects ink that has been heated and turned into a sol form. When the sol-form ink is ejected onto the recording medium P, the ink lands on the recording medium P and is then naturally cooled, so that the ink quickly turns into a gel form and solidifies on the recording medium P.

Note that the type of ink ejected from the recording head 240 is arbitrary in the image forming apparatus 1 according to the present disclosure. For example, an ultraviolet-curable hot-melt ink composition can be used.

The fixer 25 includes a UV (ultraviolet) irradiator disposed over the entire width in the width direction of the recording medium P of the conveyor 21. The fixer 25 irradiates the recording medium P placed on the conveyor 21 with energy beams, such as ultraviolet rays, from the UV irradiator, to cure and fix the ink ejected onto the recording medium P. The fixer 25 is disposed between an arrangement position of the head unit 24 and an arrangement position of a handover drum 261 of the deliverer 26.

The deliverer 26 includes a belt loop 262 having an inner surface supported by two rollers and a cylindrical handover drum 261 that transfers the recording medium P from the conveyor 21 to the belt loop 262. The deliverer 26 delivers the recording medium P onto the belt loop 262 by the handover drum 261, and then conveys the recording medium P by the belt loop 262 to send out to the sheet ejector 30.

The sheet ejector 30 includes a sheet ejection tray 31 that has a plate shape and on which the recording medium P sent by the deliverer 26 is placed. The sheet ejector 30 places the recording medium P on which the image is formed on the sheet ejection tray 31.

The color measurer 50 performs color measurement of an image formed on the recording medium P by the image former 20. The color measurer 50 according to the present embodiment is disposed, for example, at a subsequent stage of the fixer 25 so as to face the conveyance surface of the conveyance drum 211.

The color measurer 50 performs color measurement of an image formed on the recording medium P by, for example, a filter method. The color measurer 50 includes, for example, a light emitting element that emits light, a plurality of filters (for example, filters of respective colors of RGB) having different spectral transmission characteristics, and a light receiving element that receives reflected light of light via the filters.

The color measurement data obtained by the color measurer 50 is expressed, for example, on the RGB color space, and the color value of each pixel area is expressed by the density of 256 gradations of each of the colors of R, G and B.

Note that the configuration of the color measurer 50 can be variously changed. For example, the color measurer 50 may be disposed as an independent device between the deliverer 26 and the sheet ejector 30. In addition, as the color measurer 50, a unit that performs color measurement by a spectrophotometry method may be used instead of the filter method. Further, instead of outputting the color value of each pixel area as a pixel value in the RGB color space, the color measurer 50 may output the color information of each pixel area as a pixel value in the Lab color space or any other color space.

The color measurer 50 is provided with a temperature sensor 51 and a humidity sensor 52 for measuring the ambient temperature and the ambient humidity of the environment in which the recording medium P is placed. That is, the temperature sensor 51 and the humidity sensor 52 measure the ambient temperature and the ambient humidity of the environment in which the recording medium P is placed until the ink formed on the recording medium P is stabilized.

Note that arrangement positions of the temperature sensor 51 and the humidity sensor 52 can be arbitrarily changed depending on an apparatus configuration of the image forming apparatus 1. For example, it may be disposed in the image former 20 or in an external space.

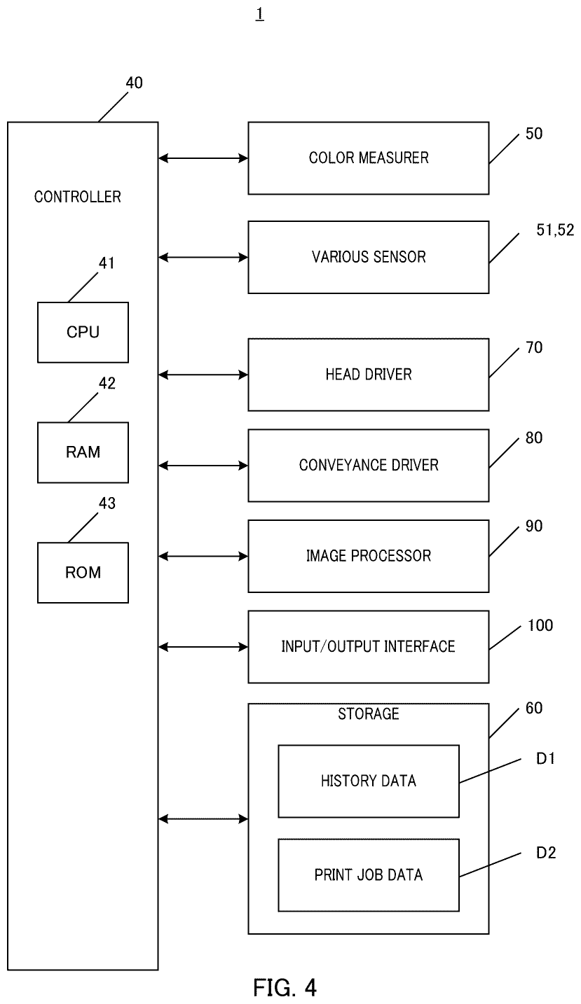

FIG. 4 is a block diagram illustrating a configuration of a control system of the image forming apparatus 1. The image forming apparatus 1 includes the controller 40, the color measurer 50, the storage 60, a head driver 70, a conveyance driver 80, an image processor 90, and an input/output interface 100.

The controller 40 includes a CPU 41, a RAM 42, and a ROM 43, and comprehensively controls the entire operation of the image forming apparatus 1. The controller 40 receives, via the input/output interface 100, image data transmitted from an external device (e.g., a computer) connected to a network such as a LAN or a WAN. Then, the head driver 70, the conveyance driver 80, the image processor 90, and the like are caused to perform an operation of forming an image on the recording medium P based on the image data (input image data).

The CPU 41 reads various control programs and data items stored in the ROM 43, stores the read programs and data in the RAM 42, and executes the programs to carry out various calculation processes.

The RAM 42 provides a working memory space for the CPU 41 and stores temporary data. The RAM 42 may include a non-volatile memory.

The ROM 43 stores various control program to be executed by the CPU 41, setting data, and the like. Note that a rewritable non-volatile memory such as an EEPROM or a flash memory may be used instead of the memory the ROM 43.

Each function (i.e., test printing and color measurement processing) of the controller 40, which will be described later, is realized by, for example, the CPU 41 referring to control programs and various kinds of information stored in a ROM 42, a RAM 43, the storage 60 and the like. However, some or all of the function may be implemented by processing by a DSP or a dedicated hardware circuit instead of or in addition to the processing by the CPU 41.

In addition, the controller 40 includes a timing unit (for example, a counter circuit) so that when a test image is formed by test printing, color measurement of the test image can be periodically performed since immediately after the image formation.

The head driver 70 receives image data subjected to image processing by the controller 40, and forms a predetermined image on the recording medium P based on the image data. Specifically, the head driver 70 applies a drive voltage corresponding to the pixel value of the image data to the head unit 24 under the control of the controller 40. As a result, an amount of ink corresponding to the pixel value of the image data is discharged (ejected) from the nozzle 243 of the recording head 240 and lands at a predetermined position on the recording medium P, thereby forming an image.

The amount of ink to be ejected from the nozzle 243 of the recording head 240 is basically adjusted based on the voltage level of a drive voltage to be applied to individual image forming elements of the recording head 240 from the head driver 70. However, in addition, it is also possible to perform adjustment by correcting the ejection gradation (the number of times of ejection per one pixel region) of each nozzle 243 of the recording head 240.

The conveyance driver 80 supplies a drive signal to a conveyance drum motor disposed on the conveyance drum 211 on the basis of the control signal from the controller 40 to rotate the conveyance drum 211 at a predetermined speed and timing. The conveyance driver 80 supplies drive signals to the motors for operating the medium supplier 12, the handover unit 22, and the deliverer 26 on the basis of the control signals from the controller 40, to cause the motors to supply the recording medium P to the conveyor 21 or eject the recording medium P from the conveyor 21.

The image processor 90 performs predetermined image processing on image data to be printed, and stores the obtained image data in the storage 60. The image processing includes color conversion processing, gradation correction processing, pseudo halftone processing, and the like.

The input/output interface 100 is connected to the input/output interface of an external device (e.g., a personal computer) and mediates transmission and reception of data between the controller 40 and the external device. The input/output interface 100 includes, for example, various serial interfaces, various parallel interfaces, or a combination of these interfaces.

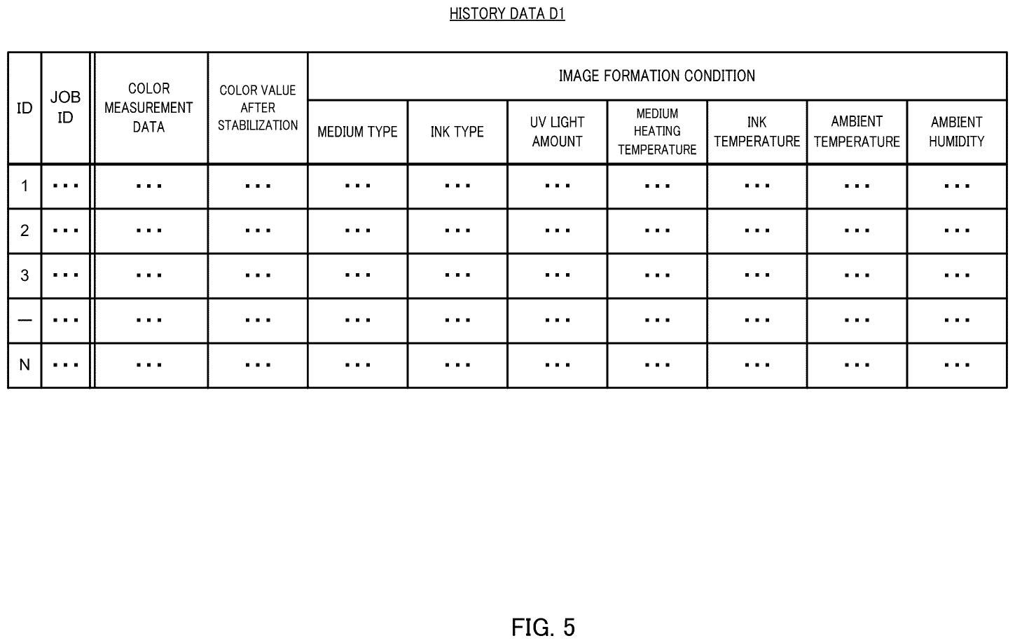

The storage 60 stores history data D1 (see FIG. 5) of color measurement results obtained in test printing performed in the past, current print job data D2, and the like. As the storage 60, for example, an HDD, a DRAM, or the like is used.

### Detailed Configuration of Controller

Hereinafter, a detailed configuration of the controller 40 will be described with reference to FIGS. 5 to 7.

The image forming apparatus 1 (controller 40) according to the present embodiment is configured to perform test printing as calibration processing before performing main printing, in order to perform tone correction or the like of a density suitable for the image formation condition, similarly to the known method. The image forming apparatus 1 then performs color measurement of the test images formed in the test printing with the color measurer 50 and performs, for example, tone correction of the densities of the input image data to be printed on the basis of the obtained color values.

The test printing is typically performed under the same image formation condition as the image formation condition for the main printing. Note that the image formation condition for the present printing is stored here in the print job data D2 to be executed.

Specifically, in the test printing, for example, the combination of the type of ink to be ejected from the recording head 240 and the type of recording medium P is selected so as to be the same combination as that in the main printing. In the test printing, the UV light amount in the fixer 25, the heating temperature of the recording medium P in the heating unit 23, and the ink temperature in the recording head 240 are set to be under the same conditions as those in the main printing. In addition, in the test printing, the ambient temperature and the ambient humidity of the surrounding environment in which the recording medium P is placed are set to be the same conditions as those in the main printing.

In the test printing, for example, the controller 40 forms a preset test image on the recording medium P by the image former 20. The test image is, for example, a plurality of color charts (for example, patch images of RGB) having different hues or gradations.

The controller 40 then continuously performs, using the color measurer 50, color measurement of the image since immediately after the formation of the image on the recording medium P by test printing, and identifies, based on time-series color measurement data, the color value of the image after color stabilization. For example, the controller 40 identifies the color measurement data obtained at the timing when an amount of change per unit elapsed time becomes equal to or smaller than a threshold value, as the final color value after the color stabilization of the image formed on the recording medium P.

However, as described above, each time test printing is performed, if waiting is actually performed until the ink is dried on the recording medium P and the color value is stabilized, printing cannot be performed during the waiting period, and downtime occurs.

Therefore, the controller 40 according to the present embodiment accumulates measurement results newly obtained in the test printing every time as the history data D1. Then, the controller 40 refers to the color measurement result of the test printing executed under an image formation condition identical or similar to that of the new test printing, among the color measurement results stored as the history data D1, and if the color measurement result can be used, the color value after the color stabilization is identified by the color measurement result.

More specifically, the controller 40 according to the present embodiment identifies the difference in transition between the time-series color measurement data of the image formed in the new test printing that have been obtained up to the current time point and the time-series color measurement data of the image formed in past test printing. Next, when the difference in transition is equal to or smaller than a predetermined value, it is determined that the color measurement results obtained for the image formed in the past test printing can be used, and the color measurement is completed at that time.

Here, the reason why the color measurement is actually temporarily performed on the image formed in the new test printing and then it is determined whether the color measurement result in the past test printing can be used is that the color of the ink after stabilization changes due to various elements. For example, even when inks containing the same main component are used, the color of the ink after stabilization may change depending on the difference in other components or additives. In addition, a difference in the manner of curing of the ink may result in a change in color of the ink after stabilization.

In the present embodiment, for convenience of description, test printing to be newly performed under the same image formation conditions as those of the actual printing before the actual printing is referred to as “current test printing” or “new test printing”. Further, test printing performed before the current test printing is referred to as “test printing performed in the past or past test printing”.

FIG. 5 is a diagram illustrating an example of the history data D1 stored in the storage 60.

The history data D1 is related to the measurement result obtained by the test printing performed in the past. To be more specific, the history database D1 stores, for example, for each job of test printing performed in the past, “time-series color measurement data”, “color value after image stabilization”, and “image formation condition” in association with one another.

Here, the “time-series color measurement data” is a color value (for example, an RGB value) of an image for each elapsed time from immediately after image formation. The color measurement data may be stored as a color difference with respect to a standard color (for example, an amount of change from an initial value).

The “color value of the image after stabilization” is, for example, a color value specified when a change amount of the color value per unit elapsed time is a threshold or less on the basis of the time-series color measurement data.

As the “image formation condition”, factors that affect the color change of the image after the image formation and the color value of the image are stored. Here, for example, as the image formation condition, “medium type”, “ink type”, “UV light amount”, “medium heating temperature”, “ink temperature”, “ambient temperature”, and “ambient humidity” are stored.

Here, the “medium type” is the type of the recording medium P on which image formation has been performed. The “medium type” is separately stored and managed for each recording medium differing in material, basis weight, thickness, and the like of the recording medium P, for example.

The “ink type” is the type of ink ejected from the recording head 240. The “ink type” is separately stored and managed for each ink differing in ink component or additive, for example. Note that in a case where ink lots are different, even inks containing the same main component may have slightly different component ratios and viscosities due to a change over time and added components. Therefore, the “ink type” is desirably handled as a different ink type when the ink lot is different.

In addition, the “UV light amount” represents the UV light amount when UV irradiation for the UV curing process is performed on the image on the recording medium P in the fixer 25. The “recording medium heating temperature” indicates the heating temperature of the recording medium P when ink is ejected from the recording head 240, and indicates, for example, the heating temperature of the recording medium P by the heating unit 23. Further, “ink temperature” represents ink heating in the recording head 240. In addition, “ambient temperature” and “ambient humidity” indicate the ambient temperature and ambient humidity of the surrounding environment where the ejected ink is placed in the process of being cured, and here, detection values of the temperature sensor 51 and the humidity sensor 52 are stored. Note that since these elements change the manner in which the ink ejected onto the recording medium P is cured, the color value of the image after color stabilization may be different depending on the conditions. From this point of view, these elements are stored and managed as separate image formation conditions on the history data D1.

Hereinafter, an example of more detailed processing of the controller 40 will be described.

FIG. 6 is a diagram illustrating an example of an operation flow of the controller 40. The flowchart illustrated in FIG. 6 is, for example, a process executed by the controller 40 according to a computer program. For example, before performing the main printing, the controller 40 performs the following test printing under the same image formation condition as those of the main printing.

In step S1, the controller 40 executes test printing under the same image formation condition as those of the main printing. Here, for example, patch images formed with reference colors of RGB are used as the test images.

In step S2, the controller 40 acquires the image formation condition in the current test printing. Here, the controller 40 acquires, for example, information related to the type of the recording medium P and the type of ink ejected from the recording head 240 as the image formation condition. In addition, the controller 40 acquires information on the UV light amount of the fixer 25, the medium heating temperature of the heating unit 23, the ink temperature of the recording head 240, the temperature detected by the temperature sensor 51, and the humidity detected by the humidity sensor 52.

In step S3, the controller 40 determines whether there is a color measurement result obtained under the image formation condition identical or similar to the image formation condition of the current test printing, among the color measurement results stored as the history data D1. That is, the controller 40 determines whether there is a color measurement result obtained under the image formation condition identical or similar to the image formation condition of the current test printing, among the color measurement results of the test printing performed in the past.

Here, when there is the measurement result of the image formation condition identical or similar to that of the current test printing in the history data D1 (S3: YES), the controller 40 advances the process to step S7. On the other hand, when there is no measurement result of the image formation condition identical or similar to the current test printing in the history data D1 (S3: NO), the controller 40 advances the process to step S4.

Here, in order to identify the color value after the color stabilization of the image formed in the current test printing at an early stage, the controller 40 performs processing of confirming whether there is a usable measurement result in the history data D1. Subsequent processing in step S4 to S6 is a normal color measurement flow for a case where there is no usable measurement result in the history data D1. On the other hand, the processing of step S7 to S10 is a time-saving color measurement flow for a case where there is a usable measurement result in the history data D1.

In step S3, when there is the measurement result of the image formation condition identical or similar to that of the current test printing in the history data D1 (S3: YES), the controller 40 sets the measurement result as a target to be referred to in step S9.

In step S3, when there are a plurality of measurement results of the image formation condition identical or similar to that of the current test printing in the history data D1 (S3: YES), the controller 40 refers to, for example, the measurement result in which the image formation condition most closely matches that of the current test printing. In particular, the controller 40 preferentially refers to the color measurement result using the same medium type and ink type as the current test printing in the history data D1. Next, the controller 40 assigns subsequent priority levels to the degree of similarity in terms of the UV light amount of the fixer 25, the medium heating temperature of the heating unit 23, the ink temperature of the recording head 240, the temperature detected by the temperature sensor 51, and the humidity detected by the humidity sensor 52.

In step S3, the controller 40 may also refer to a measurement result in which the image formation condition partially matches the image formation condition of the current test printing even if the image formation condition does not completely match the image formation condition of the current test printing in the history data D1. In addition, a measurement result having a high degree of similarity of the image formation condition may be set as a reference target. In this case, a similarity determination method related to the image formation condition may be set in advance, and the controller 40 may refer to the measurement result having the highest similarity in terms of the current test printing and the image formation condition from the history data D1 based on the similarity determination method.

First, the normal color measurement flow of steps S4 to S6 will be described.

In step S4, the controller 40 executes color measurement of a test image using the color measurer 50.

Note that at this time, if the color value of the test image obtained by the color measurement indicates an abnormality, the controller 40 may interrupt this series of operation flows and notify the user.

In step S5, the controller 40 refers to the color measurement data obtained in step S4 and determines whether the color change between the color measurement data (color value) obtained at the current time point and the color measurement data (color value) measured immediately before is within a threshold value. When the color change between the currently obtained color measurement data and the color measurement data measured immediately before is not within the threshold (S5: NO), the controller 40 returns to step S4 and executes color measurement again. When the color change between the currently obtained color measurement data and the color measurement data measured immediately before is within the threshold (S5: YES), the controller 40 advances the process to step S6.

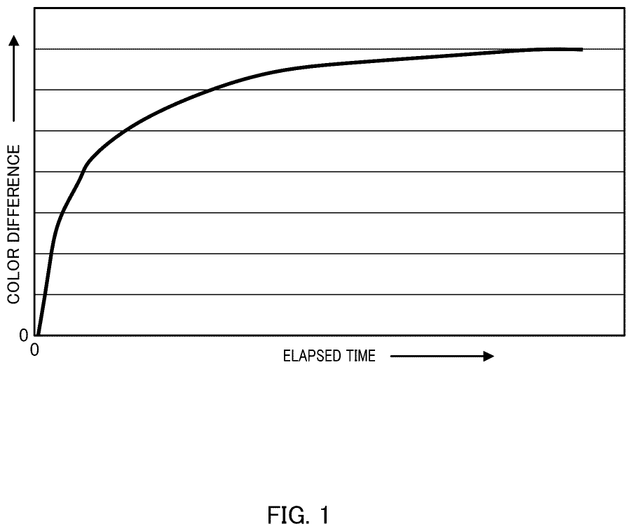

As described with reference to FIG. 1, it takes a certain time for the color value of an image (i.e., ink) after image formation to stabilize. Therefore, in step S4 and step S5, the controller 40 periodically measures the color value of the image since immediately after the image formation, monitors the change amount of the color value per unit elapsed time, and waits until the color value is stabilized. Note that the controller 40 repeatedly executes the processes of step S4 and step S5, for example, at intervals of 10 seconds.

In step S6, the controller 40 determines the final color value and stores time-series color measurement data in the storage 60. At this time, the controller 40 stores, in addition to the time-series color measurement data, the image formation condition for the current test printing and the finally determined color values in the storage 60 (see FIG. 5). Thus, the normal color measurement flow ends. Note that in this step S6, the data stored in the storage 60 will be added to the history data D1 as a new measurement result.

Next, the time-saving color measurement flow of step S7 to S10 will be described.

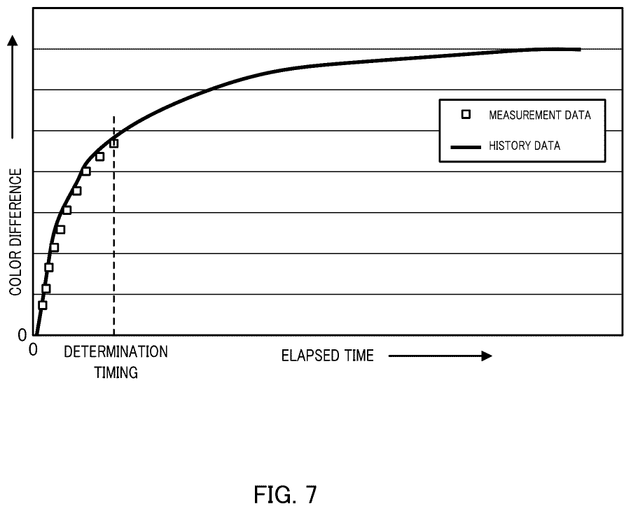

FIG. 7 is a diagram illustrating a time-saving color measurement flow of step S7 to S10. The curve in FIG. 7 is a graph obtained by connecting, with a straight line, the time-series color measurement data obtained for the test images of the past test printing. Further, the plots in FIG. 7 represent the color measurement data obtained for the test image in the current test printing. Note that in FIG. 7, the color measurement data (color value) at each measurement time point is expressed as a color difference from the color value obtained by the first measurement.

In step S7, the controller 40 uses the color measurer 50 to perform color measurement of the image formed by the current test printing.

Note that at this time, when the color value of the test image obtained by the measurement indicates an abnormality, the controller 40 may interrupt this series of operation flows and notify the user.

In step S8, the controller 40 determines whether a predetermined time has elapsed since immediately after an image is formed by test printing. Here, when the predetermined time has not elapsed (S8: NO), the controller 40 returns to step S7 and executes color measurement again. On the other hand, when the predetermined time has elapsed (S8: YES), the controller 40 proceeds to step S9.

The “predetermined time” in step S8 is a waiting period until a tendency of a locus of a change in the color value drawn by the time-series color measurement data appears to some extent. That is, the “predetermined time” is set to an appropriate determination timing (for example, three minutes) for determining a degree of coincidence between the trajectory of the change in the color value of the image formed in the current test printing and the trajectory of the change in the color value of the image formed in the past test printing. Note that the controller 40 repeatedly executes the processing in step S7 and step S8 at 10-second intervals, for example, until the predetermined time elapses.

In step S9, the controller 40 compares the time-series measurement data obtained for the test image of the current test printing with the time-series measurement data obtained for the test image of the past test printing determined as the reference target in step S3. Next, the controller 40 determines whether the difference in color change transition between the two is within a predetermined value. If the difference in color change transition between the two is within the predetermined value (S9: YES), the controller 40 advances the process to step S10. On the other hand, when the difference in color change transition between the two is not within the predetermined value (S9: NO), the controller 40 advances the process to step S4.

In step S9, for example, the controller 40 calculates the difference between two pieces of measurement data at each measurement timing during a period from immediately after the formation of the image to the lapse of a predetermined time. Then, the controller 40 determines whether the difference in color change transition between the two is within a predetermined value on the basis of the accumulated value of the difference from the measurement data.

Note that any method can be used to calculate the difference in color change transition between the two. For example, the similarity between the transition curve indicated by the time-series measurement data obtained for the image of the current test printing and the transition curve indicated by the time-series measurement data obtained for the image of the past test printing may be set as the difference in the color change transition between the both. At this time, the difference in color change transition between the two may be expressed by a ratio or the like.

Note that the reason why the process proceeds to step S4 here if the difference in the color variation transition between the two is not within the predetermined value (S9: NO) is that in such a case, the image formed in the current test printing is independently subjected to the normal color measurement flow. This is because such a case indicates a mode in which the behavior of the color change until stabilization is different between the image formed in the current test printing and the image formed in the past test printing due to some factor among the image formation conditions.

In step S10, the controller 40 confirms the final color value confirmed by the measurement result of the past test printing determined as the reference target in step S3 as the final color value of the image formed by the current test printing, and completes the color measurement. This is because, when the difference between the two color variation transitions is within the predetermined value (S9: YES), it is estimated that the image formed in the current test printing is stabilized in the same manner as the image formed in the past test printing. That is, this makes it possible to identify, at an early stage, the color value after the color stabilization of the image formed in the current test printing.

By the operation flow as described above, the controller 40 according to the present embodiment can specify the color value after the color stabilization of the test image. As a result, the controller 40 can grasp what kind of color correction processing should be performed on the input image data when performing the actual printing. Note that the color correction processing itself to be performed thereafter is the same as a known method, and hence a description thereof is omitted here.

### Effects

As described above, an image forming apparatus includes: an image former that forms an image on a recording medium by ink ejection; a color measurer that performs color measurement of the image formed on the recording medium; a controller (or hardware processor) that controls operations of the image former and the color measurer to: perform test printing; continuously perform the color measurement of the image since immediately after the image is formed in the test printing; and identify a color value after color stabilization of the image based on time-series color measurement data; and a storage (or memory) that stores, as history data, color measurement results and image formation conditions in past test printing in association with each other. While performing new test printing and continuously performing the color measurement of the image formed in the new test printing, the controller refers to, from among the color measurement results stored as the history data, a color measurement result under an image formation condition identical or similar to an image formation condition of the new test printing. Upon identifying that a difference in transition between the time-series color measurement data of the image formed in the new test printing that has been obtained up to a current time point and the time-series color measurement data on the color measurement result stored as the history data that has been referred to is equal to or smaller than a predetermined value, the controller terminates the color measurement at that time point.

Therefore, according to the image forming apparatus of the present embodiment, it is possible to shorten the waiting time until the color value after color stabilization of the current image of the color measurement target is specified while maintaining accurate reproducibility for various use situations.

In the image forming apparatus according to the present embodiment, when performing the color measurement of the image formed in the new test printing until completion of the color measurement without using the color measurement result stored as the history data, the controller stores, as the new color measurement result, the time-series color measurement data of the image formed in the new test printing until the completion of the color measurement, and the color value after the color stabilization, in the storage in association with the image formation condition in the new test printing.

Therefore, according to the image forming apparatus of the present embodiment, when the color measurement is performed until the color becomes stable under an image formation condition which is not stored in the storage, the measurement result can be sequentially accumulated in the storage so as to be used as a reference source for another printing in the future.

The image forming apparatus according to the present disclosure is not limited to the above-described embodiment and is applicable to various application aspects and modification aspects.

### Application Example 1

Upon completion of the color measurement of the test image, the controller 40 may output, as a report, the time-series color measurement data on the image until the completion of the color measurement, the color value after color stabilization, and the image formation condition. Note that the report may be output in any manner. For example, the contents of the report may be printed on a sheet and output, or the report may be displayed and output on a monitor (not illustrated).

Thus, it is possible to enable a user to recognize the color measurement result of the test image before performing the main printing.

### Application Example 2

In the process of the flowchart of FIG. 6, when it is determined in step S9 that the color measurement result of the history data D1 can be used, the controller 40 may perform a process of notifying the user of the determination result and waiting for an instruction from the user. That is, the controller 40 may specify the color value after the color stabilization of the test image on the basis of the color measurement result of the history data D1 only when the permission to use the color measurement result of the history data D1 is obtained by the user.

Thus, in a case where the user actually desires to obtain color measurement data of a test image after color stabilization in the normal color measurement mode, it is possible to change to such a usage manner.

### Application Example 3

The controller 40 may be configured to transmit the history data D1 stored in the storage 60 to an external management apparatus (not illustrated) and register the history data D1 in a database of the external management apparatus. In addition, in this case, the controller 40 may set the history data D1 obtained by another apparatus registered in the database of the external management apparatus as a search target in step S3 in the process of the flowchart of FIG. 6.

This makes it possible to share the history data D1 among a plurality of image formation apparatuses. That is, as a result, when the printing under the image formation condition which has not been performed in the own apparatus has already been performed in another apparatus, the controller 40 can use the color measurement result after the color stabilization obtained at that time in the time shortening color measurement mode.

Although embodiments of the present invention have been described and illustrated in detail, it is clearly understood that the same is by way of illustration and example only and not limitation, the scope of the present invention should be interpreted by terms of the appended claims.

What is claimed is:

1. An image forming apparatus comprising:
an image former that forms an image on a recording medium by ink ejection;
a color measurer that performs color measurement of the image formed on the recording medium;
a hardware processor that controls operations of the image former and the color measurer to: perform test printing; continuously perform the color measurement of the image since immediately after the image is formed in the test printing; and identify a color value after color stabilization of the image based on time-series color measurement data; and
a memory that stores, as history data, color measurement results and image formation conditions in past test printing in association with each other, wherein
while performing new test printing and continuously performing the color measurement of the image formed in the new test printing, the hardware processor refers to, from among the color measurement results stored as the history data, a color measurement result under an image formation condition identical or similar to an image formation condition of the new test printing, and
upon identifying that a difference in transition between the time-series color measurement data of the image formed in the new test printing that has been obtained up to a current time point and the time-series color measurement data on the color measurement result stored as the history data that has been referred to is equal to or smaller than a predetermined value, the hardware processor terminates the color measurement at that time point.

2. The image forming apparatus according to claim 1, wherein in a state where the color measurement result stored as the history data is usable, the hardware processor identifies the color value after the color stabilization of the image formed in the new test printing based on the color value after the color stabilization of the image finally identified in the color measurement result stored as the history data.

3. The image forming apparatus according to claim 1, wherein the image formation condition includes a combination of a type of the recording medium and a type of ink used by the image former.

4. The image forming apparatus according to claim 1, wherein the image formation condition includes an ultraviolet light amount in an ultraviolet curing process on the image formed on the recording medium.

5. The image forming apparatus according to claim 1, wherein the image formation condition includes a heating temperature of the recording medium for image formation by the image former.

6. The image forming apparatus according to claim 1, wherein the image formation condition includes an ink temperature of discharged ink for image formation by the image former.

7. The image forming apparatus according to claim 1, wherein the image formation condition includes an ambient temperature and an ambient humidity of a surrounding environment of the image former or the color measurer.

8. The image forming apparatus according to claim 1, wherein upon completion of the color measurement of the image formed in the new test printing, the hardware processor outputs, as a report, the time-series color measurement data until the completion of the color measurement of the image, the color value after the color stabilization, and the image formation condition.

9. The image forming apparatus according to claim 1, wherein in a state where the color measurement result stored as the history data is usable, the hardware processor notifies a user that the color measurement result stored as the history data is usable, and upon permission by the user, the hardware processor identifies the color value of the image formed in the new test printing after the color stabilization based on the color measurement result stored as the history data.

10. The image forming apparatus according to claim 1, wherein the hardware processor transmits the history data stored in the memory to an external management apparatus, and registers the history data in a database of the external management apparatus.

11. The image forming apparatus according to claim 1, wherein in a case where the color measurement result stored as the history data include no color measurement result of the test printing under the image formation condition identical or similar to the image formation condition of the new test printing, and in a case where the difference in transition between the time-series color measurement data of the image formed in the new test printing that has been obtained up to the current time point and the time-series color measurement data on the color measurement result stored as the history data that has been referred to is greater than the predetermined value, the hardware processor continues the color measurement until an amount of change in the color value of the image formed in the new test printing per unit elapsed time becomes equal to or smaller than a threshold.

12. The image forming apparatus according to claim 1, wherein when performing the color measurement of the image formed in the new test printing until completion of the color measurement without using the color measurement result stored as the history data, the hardware processor stores, as the new color measurement result, the time-series color measurement data of the image formed in the new test printing until the completion of the color measurement, and the color value after the color stabilization, in the memory in association with the image formation condition in the new test printing.

13. A control method for an image forming apparatus that performs test printing and continuously performs color measurement of an image since immediately after the image is formed on a recording medium in the test printing, and identifies a color value after color stabilization of the image based on time-series color measurement data, the method comprising:
storing, as history data in a memory, color measurement results and image formation conditions in past test printing in association with each other;
referring to, from among the color measurement results stored as the history data, a color measurement result under an image formation condition identical or similar to an image formation condition of new test printing; and
upon identifying that a difference in transition between the time-series color measurement data of the image formed in the new test printing that has been obtained up to a current time point and the time-series color measurement data on the color measurement result stored as the history data that has been referred to is equal to or smaller than a predetermined value, terminating the color measurement at that time point.
